(19) United States
(12) Patent Application Publication
(10) Pub. No.: US 2014/0329031 A1
(43) Pub. Date: Nov. 6, 2014

(54) METHOD FOR FORMING COMPLEX FILM OF DIAMOND-LIKE CARBON AND SILICON CARBIDE

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/014,423

(22) Filed: Aug. 30, 2013

(30) Foreign Application Priority Data
May 2, 2013 (TW) 102115675

(51) Int. Cl. B29C 33/58

(52) U.S. Cl. CPC B29C 33/58
USPC 427/577

(57) ABSTRACT

A method for applying a resin-repellant coating to an injection molding component made of metal forms a complex film of diamond-like carbon (DLC) and silicon carbide (SiC) on the metal. A vacuum chamber is evacuated of air and an electric field is created in the chamber. A first gas containing carbon and a second gas containing silicon interact with an ionized noble gas as a working gas in the chamber. A first film of SiC is deposited and bonded on the metal die, a second film of DLC from excess carbon atoms is then deposited and bonded on the first film to form the complex film.

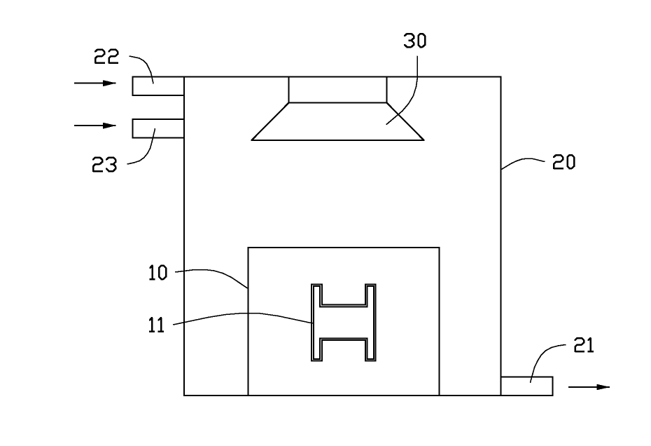

### BACKGROUND

1. Technical Field

The present disclosure relates to a method for forming complex film of diamond-like carbon and silicon carbide.

2. Description of Related Art

Optical fiber connectors are made by injection molding machines. The injection molding machines include core die made of metal for forming the optical fiber connectors. Material of the optical fiber connectors generally are polyetherimide (PEI) resin. Because of viscosity, a little PEI resin will stay on the core die. In injection process, a little PEI resin can affect the shape and performance of the optical fiber connectors and small flaws can form on the surface of the optical fiber connectors.

Diamond-like carbon (DLC) film can enhance the resin-repellence of the core die, but the difficulty is depositing a DLC film on surface of the core die made of metal.

Therefore, it is desirable to provide a method for forming complex film of diamond like carbon and silicon carbide, which can overcome the limitation described.

### BRIEF DESCRIPTION OF THE DRAWING

The components of the drawing are not necessarily drawn to scale, the emphasis instead being placed upon clearly illustrating the principles of the embodiments of the present disclosure.

The FIGURE is a schematic view of a chamber for implementing an embodiment of a method for forming complex film of diamond-like carbon and silicon carbide.

### DETAILED DESCRIPTION

The figure shows a chamber 20 for implementing an embodiment of a method for forming complex film of diamond-like carbon and silicon carbide (SiC). A power supply 30 is located in the chamber 20.

The power supply 30 is switched on to create an electric field in the chamber 20. The electric field can drive a working gas to move in a high speed and form a plasma within the electric field. The working gas generally is a noble gas, for example, hydrogen, argon, or helium. The power supply 30 can be a direct current power supply, radio-frequency (RF) power supply, or microwave power supply.

A first opening 21, a second opening 22, and a third opening 23 are defined on a same side or different sides of the chamber 20. One of the first opening 21, the second opening 22, and the third opening 23 is an exit for gases. The other two openings are entrances for gases.

Steps of the method for forming complex film are as follows.

One or more metal workpieces 10 are cleaned and then placed into the chamber 20.

Air in the chamber 20 is evacuated through the first opening 21. After gas evacuation, air pressure in the chamber 20 is between 10⁻³ torr and 10⁻⁵ torr.

A first gas containing carbon element is applied into the chamber 20 through the second opening 22 and a second gas containing silicon element is applied into the chamber 20 through the third opening 23. The working gas is applied into the chamber 20 together with the first gas or together with the second gas.

The ratios by volume of the first gas, the second gas, and the working gas are 100:5:1 respectively. In other words, 100 parts of the first gas, 5 parts of the second gas, and one part of the working gas are applied into the chamber 20.

The first gas can be methane or ethyne. The second gas can be hexamethyldisiloxane (HMDSO) or silane.

Under the electric field in the chamber 20, the working gas in the chamber 20 is accelerated to high speed. The working gas strikes the first gas and the second gas, and ionizes both the first gas and the second gas. Carbon ions and silicon ions are separated from the first gas and the second gas respectively. The number of the carbon ions is greater than that of the silicon ions. A chemical reaction between the carbon ions and the silicon ions occurs and silicon carbide is produced. The silicon carbide is deposited on the metal workpiece 10. The excess of carbon ions is deposited onto the metal workpiece 10 to form diamond-like carbon and thus a complex film 11 of diamond-like carbon and silicon carbide is formed on the metal workpiece 10.

The silicon element content makes that the water contact angle (liquid-repelling property) of the complex film 11 is larger than 100 degrees.

Thickness of the complex film 11 is 300 nanometers, friction coefficient of the complex film 11 is smaller than 0.01, hardness of the complex film 11 is 3000 Hv, and smoothness of the complex film 11 is smaller than 10 nanometers in variation.

Diamond-like carbon and silicon carbide integrates with each other and a good bond is created between the silicon carbide and the metal workpiece 10, so the overall bonding of the complex film 11 to the metal workpiece 10 is enhanced.

It is believed that the present embodiments and their advantages will be understood from the foregoing description, and it will be apparent that various changes may be made thereto without departing from the spirit and scope of the disclosure or sacrificing all of its material advantages, the examples hereinbefore described being merely exemplary embodiments of the disclosure.

What is claimed is:

1. A method for forming a complex film of diamond like carbon and silicon carbide, comprising:
vacuuming a chamber, the chamber receiving a power supply;
applying a first gas containing carbon element, a second gas containing silicon element, and a working gas into the chamber; and
turning the power supply on to generate an electric field in the chamber, the electric field making the working gas to move in a high speed and making the working gas strike the first gas and the second gas, such that the first gas and the second gas are ionized to generate carbon ions and silicon ions, the carbon ions chemically reacting with the silicon ions to obtain a complex film of diamond-like carbon and silicon carbide.

2. The method of claim 1, wherein the first gas is selected from a group consisting of methane and ethyne.

3. The method of claim 1, wherein the second gas is selected from a group consisting of examethyldisiloxane and silane.

4. The method of claim 1, wherein a ratio of the first gas and the second gas is 100:5.

5. The method of claim 1, wherein a thickness of the complex film is 300 nanometers.

6. The method of claim 1, wherein a water contact angle of the complex film is larger than 100 degrees.

7. The method of claim 1, wherein the roughness of the complex film is smaller than 10 nanometers.

8. The method of claim 1, wherein the hardness of the complex film is 3000 Hv.

9. The method of claim 1, wherein the friction coefficient of the complex film is 0.01.

10. The method of claim 1, wherein the back pressure of the chamber is between 10⁻³ torr and 10⁻⁵ torr.
